(19) United States
(12) Patent Application Publication
(10) Pub. No.: US 2007/0119219 A1
(43) Pub. Date: May 31, 2007

(54) COMPUTER LOCK AND CORRESPONDING SECURITY HOLE PATTERN

(75) Inventors: Germain DeMartinis, Northridge, CA (US); Douglas Toby Brown, Santee, CA (US)

Correspondence Address: SIERRA PATENT GROUP, LTD., 1657 Hwy 395, Suite 202, Minden, NV, 89423, US

(73) Assignee: ANNETTE, LLC, (US)

(21) Appl. No.: 11/466,386

(22) Filed: Aug. 22, 2006

Related U.S. Application Data
(60) Provisional application No. 60/710,438, filed on Aug. 22, 2005.

(51) Int. Cl. E05B 73/00

(52) U.S. Cl. 70/58

(57) ABSTRACT

A computer lock that comprises a body, preferably made out of metal, having a top hook, a center post, and a bottom hook. The two hooks fit into two specially located and sized corresponding slots that are built into a computer chassis. The center post fits into a specially located and sized corresponding hole that is built into the computer chassis, thereby preventing the computer lock from being improperly removed from the computer chassis. The computer lock also includes a security cable slot or channel for attaching a security cable and a cable trap protecting peripheral devices (such as mouse and keyboard) against theft.

### CROSS-REFERENCE TO RELATED APPLICATIONS

This application claims priority to U.S. Provisional Application Ser. No. 60/710,438, filed Aug. 22, 2005, which is hereby incorporated by reference as if set forth herein.

### BACKGROUND

The present invention relates to computer locks. More particularly, the present invention relates to a computer lock configured for use with a corresponding security hole pattern. As computers and computer-related products have become more and more popular, the issue of protecting these products from tampering and theft has become more and more important. What is needed in the art is a computer lock that is strong, secure and easy to use.

### SUMMARY

The present invention is a useful, novel, and unobvious computer lock which is stronger and more user friendly than current computer locks. The computer lock is configured for use with a corresponding security hole pattern.

In one aspect of the present invention, a computer lock is provided comprising: a lock body having a front end, a back end opposite the front end, a first side adjacent to the back end, a second side opposite the first side and adjacent to the back end, a top portion, and a bottom portion opposite the top portion; a top hook disposed on the top portion between the first side and the second side, the top hook protruding outward from the back end; a bottom hook disposed on the bottom portion between the first side and the second side, the bottom hook protruding outward from the back end; a post disposed in between the top hook and the bottom hook and between the first side and the second side, the post configured to protrude outward from the back end either in a fixed position or in an adjustable position; and an opening disposed in between the top hook and the bottom hook and extending from the back end towards the front end, the opening having a security cable slot and a cable trap formed therein, wherein the security cable slot is configured to receive and anchor a security cable having an elongated body and an end that is greater in diameter than the elongated body, and the cable trap is configured to receive cables and trap the cables in between the front end and a surface to which the back end is secured.

In another aspect of the present invention, a security hole pattern for a computer chassis is provided comprising: a top slot disposed on the computer chassis, the top slot configured to receive and support a top hook; a hole disposed on the computer chassis in a position below the top slot, the hole configured to receive and support a post; and a bottom slot disposed on the computer chassis in a position below the hole, the bottom slot configured to receive and support a bottom hook, wherein the top slot, the hole and the bottom slot all comprise substantially the same horizontal position on the computer chassis.

### DESCRIPTION OF THE DRAWINGS

FIG. 1A is a front perspective view illustrating the structure and operation of an exemplary computer lock and security hole pattern according to the present invention;

FIG. 1B is a side view illustrating the structure and operation of an exemplary computer lock according to the present invention;

FIG. 1C is a back perspective view illustrating the structure and operation of an exemplary computer lock according to the present invention;

FIG. 2 is a front view of a computer chassis having an exemplary security hole pattern according to the present invention;

FIG. 3A is another side view illustrating the structure and measurements of an exemplary computer lock according to the present invention;

FIG. 3B is a front view of illustrating the structure and measurements of an exemplary computer lock according to the present invention;

FIG. 4A is a side view illustrating the structure and operation of a second embodiment of an exemplary computer lock according to the present invention;

FIG. 4B is a back perspective view illustrating the structure and operation of the second embodiment of an exemplary computer lock according to the present invention;

FIG. 4C is a front perspective view illustrating the structure and operation of the second embodiment of an exemplary computer lock according to the present invention;

FIG. 5A is a front perspective view illustrating the structure and operation of a third embodiment of an exemplary computer lock and security hole pattern according to the present invention; and

FIG. 5B is a back perspective view illustrating the structure and operation of the third embodiment of an exemplary computer lock according to the present invention.

### DETAILED DESCRIPTION

Persons of ordinary skill in the art will realize that the following disclosure is illustrative only and not in any way limiting. Other embodiments of the invention will readily suggest themselves to such skilled persons having the benefit of this disclosure.

The present invention is a device for locking a computer chassis closed in order to protect the computer's internal components against theft, while also anchoring the entire computer system (including peripheral devices, such as a mouse and keyboard, against theft.

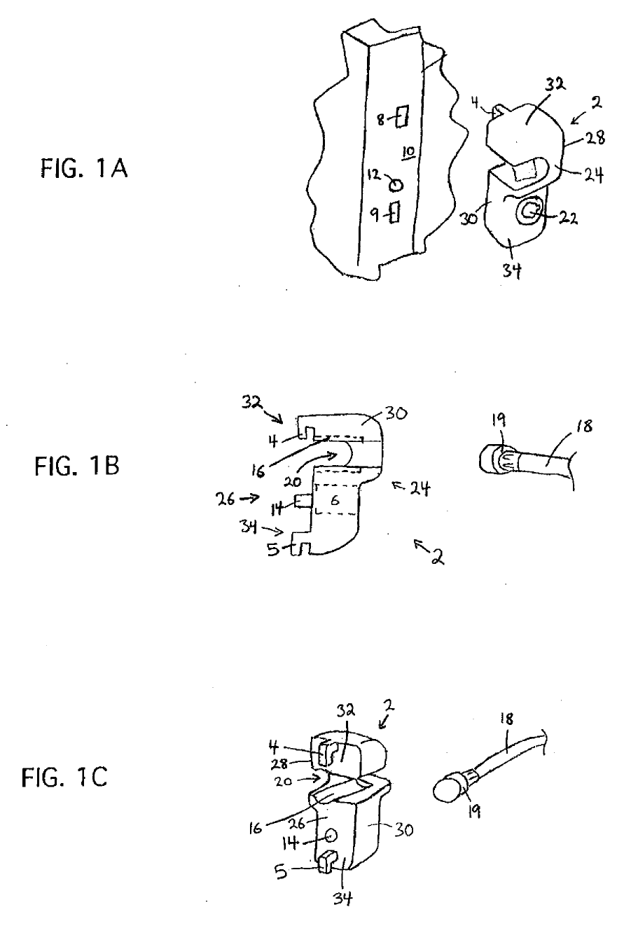

FIGS. 1A-5B illustrate exemplary embodiments of the computer lock and corresponding security hole pattern of the present invention, with like components being numbered alike.

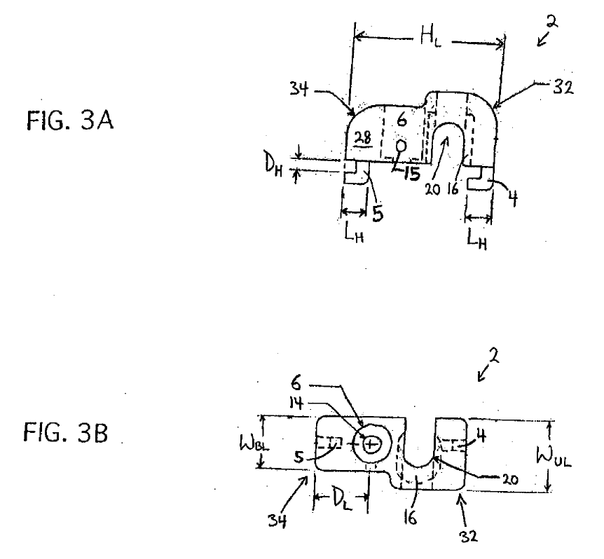

FIGS. 1A-1C and 3A-3B illustrate an exemplary embodiment of computer lock 2 and the security hole pattern of the present invention. Computer lock 2 comprises a body, preferably made out of metal, having top hook 4, center post 14, and bottom hook 5. The two hooks 4 and 5 fit into two specially located and sized corresponding slots, top slot 8 and bottom slot 9, that are built into computer chassis 10. Center post 14 fits into a specially located and sized corresponding hole 12 that is built into computer chassis 10, thereby preventing computer lock 2 from being improperly removed.

The body of lock 2 comprises a top portion 32, a bottom portion 34 opposite top portion 32, a front end 24, and a back end 26 opposite front end 24. Lock 2 also comprises first side 28, which is adjacent and runs substantially perpendicular to front end 24 and back end 26, and second side 30 opposite first side 28. Second side 30 also is adjacent and runs substantially perpendicular to front end 24 and back end 26.

In a preferred embodiment, both top hook 4 and bottom hook 5 protrude outwards from back end 26, with top hook 4 being disposed on top portion 32 and bottom hook 5 being disposed on bottom portion 34. Preferably, hooks 4 and 5 are positioned at a location about halfway in between first side 28 and second side 30. While FIGS. 1A-1C and 3A-3B show top hook 4 and bottom hook 5 being substantially L-shaped, it is contemplated that top hook 4 and bottom hook 5 may comprise any hook-shape that is curved or bent back at an angle such that it can catch hold of another structure, such as chassis 10. However, the end of top hook 4 and bottom hook 5 preferably comprise a member that extends downward away from top portion 32. In a preferred embodiment, hooks 4 and 5 are both disposed in a fixed position and orientation on back end 26. Additionally, back end 26 preferably only comprises two hooks and is substantially planar with the exception of the two protruding hooks.

Computer lock 2 also comprises lock cylinder 6 positioned in between top hook 4 and bottom hook 5. In a preferred embodiment, lock cylinder 6 is disposed on the lower half of lock 2 proximate bottom portion 34. When engaged (locked), such as by a key or any other means known in the art, lock cylinder 6 engages hole 12 that is specially located and sized between slots 8 and 9 on chassis 10. In operation, hooks 4 and 5 are placed into corresponding slots 8 and 9 so that they are hanging on chassis 10. When locked into place, back end 26 of lock 2 is preferably positioned right next to chassis 10 so that the body of lock 2 protects hooks 4 and 5 against prying and other attacks using various tools. In this fashion, the lock's body serves to house the hooks against damage when the device is locked into computer chassis 10. Locking lock cylinder 6 causes center post 14 to emerge from lock cylinder 6 through back end 26 and engage hole 12, thereby locking hooks 4 and 5 into a position so that they can not be removed or otherwise disengaged from chassis slots 8 and 9.

Lock cylinder 6 may be any locking cylinder known in the art that is configured to have center post 14 emerge from back end 26 when activated from front end 24 and have center post 14 lock into position until unlocked by a key or key-like mechanism. Center post 14 is preferably a movable, spring-loaded pin that extends from back end 24 when engaged. In a preferred embodiment, center post 14 may be activated by the user simply pushing against lock cylinder 6 from front end 24. Lock cylinder 6 may comprise locking pin 15, shown in FIG. 3A, for locking center post 14 in place. In one embodiment, lock 2 comprises key slot 22 configured to receive key 36, and thereby enable the unlocking of lock cylinder 6 and disengagement of center post 14 from hole 12. While center post 14 is shown as being substantially cylindrical in shape, it is contemplated that center post 14 may comprise any size and shape that corresponds to the size and shape of hole 12 on chassis 10. In the same spirit, while hole 12 is shown as being substantially circular in shape, it is contemplated that hole 12 may comprise any size and shape that corresponds to the size and shape of center post 14. For example, center post 14 and hole 12 may be configured in shapes including, but not limited to, rectangles, triangles, trapezoids, and the like.

Computer lock 2 also includes a security cable slot or channel 16 for attaching a security cable 18. Security cable 18 comprises an elongated body that terminates in cable end 19 that is larger in diameter than the elongated body of security cable 18. Lock 2 comprises an opening that is disposed between top hook 4 and bottom hook 5, preferably near top portion 32 and above lock cylinder 6. This opening extends from back end 26 to front end 24 and comprises a section proximate front end 24 that is smaller in diameter than cable end 19, thereby allowing the body of security cable 18 to pass through the body of lock 2 from back end 26 to front end 24, yet blocking cable end 19. Security cable slot 16 represents a portion of this opening that is larger in diameter than the rest of the opening and sized to receive cable end 19. In a preferred embodiment, slot 16 is a channel that has a diameter that is at least slightly greater than the diameter of cable end 19. Security cable slot 16 preferably is disposed between first side 28 and second side 30 and extends from back end 26 to a location preceding front end 24. Slot 16 does not extend all the way to front end 24. In this fashion, cable end 19 may travel through slot 16 from back end 26 to front end 24, but is blocked from exiting the body of lock 2 by the termination of slot 16 before front end 24 and the decreased size in diameter of the opening at first side 2 and second side 30. Security cable 18 may first be wrapped around or otherwise anchored to a piece of furniture, such as a desk, then attached to lock 2 as described above so that the computer is anchored against theft.

On second side 30, the opening extends all the way from back end 26 to front end 24, thereby allowing the security cable 18 to be placed through second side 30 and pulled towards front end through slot 16. The configuration of this opening also allows security cable 18 to be rotated or pivoted about lock 2 from front end 24 towards back end 26, only being blocked by the computer chassis to which lock 2 is attached. In this fashion, the opening allows for a rotation of about 90 degrees from front end 24 to back end 26. In addition to allowing for easier access to the lock cylinder key slot 22, this pivoting ability provides more options when space restrictions are limited behind the computer unit. Specifically, this allowance for rotation makes it possible for security cable 18 to point directly out from front end 24 or from either first side 28 or second side 30 of lock 2.

On first side 28, the opening extends from back end 26 to a location preceding front end 24. In a preferred embodiment, the opening on first side 28 extends from back end 26 to about halfway between back end 26 and front end 24. This opening on lock 2 provides a cable trap 20, which protects peripheral devices (such as mouse and keyboard) against theft. Cable trap 20 is a specifically sized tunnel that runs from first side 28 to second side 30, allowing for peripheral cables (such as the wire of a mouse or keyboard) to be placed through it. When lock 2 is locked onto computer chassis 10, cable trap 20 serves to trap the peripheral cables between lock 2 and chassis 10 so that they cannot be removed. For example, the user can slide security cable 18 into security cable slot 16 in a direction away from back end 26. The user may then place any peripheral cables in cable trap 20, running them substantially perpendicular to the direction of security cable 18. Lock 2 would then be placed and locked onto the chassis 10, thereby securing security cable 18 and the peripheral cables.

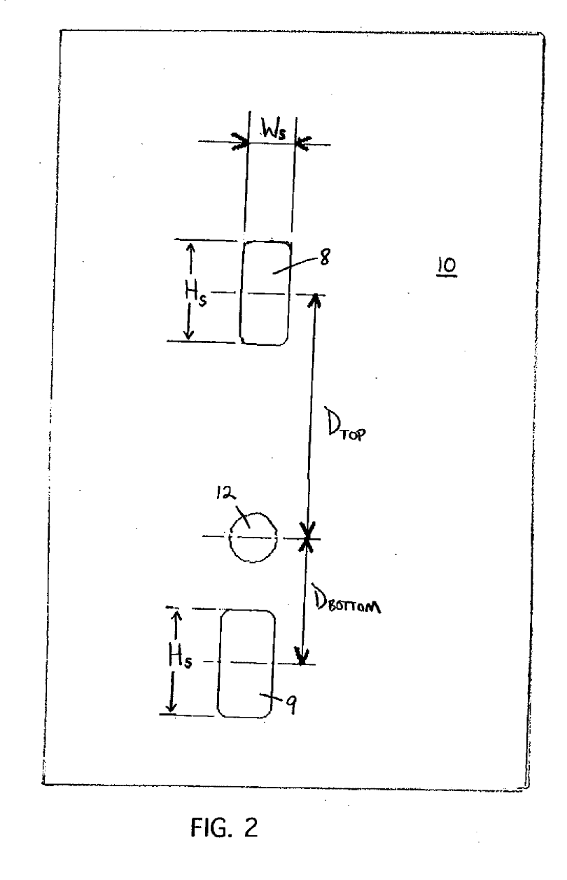

Referring to FIG. 2, the corresponding security hole pattern of the present invention is illustrated as a series of specifically defined holes and slots used for the attachment of a security lock to a computer chassis 10: The purpose of the security hole pattern is to provide an attachment mechanism that allows a defined security lock to protect a computer, or other equipment bearing the security hole pattern, against theft or tampering. As discussed above, the security hole pattern comprises top slot 8, bottom slot 9 and central hole 12 configured to receive top hook 4, bottom hook 4 and center post 14 respectively. Preferably, top slot 8, bottom slot 9 and hole 12 are aligned in the same horizontal position on chassis 10, and top hook 4, bottom hook 5 and center post 14 are similarly aligned in the same horizontal position on lock 2. Hole 12 is disposed in between top slot 8 and bottom slot 9, preferably at a location closer to bottom slot 9.

Slots 8 and 9 have a width W_{S} and a height Hₛ. In a preferred embodiment, Wₛ is approximately 3+/−0.2 millimeters, while Hₛ, is approximately 7 +/−0.2 millimeters. Hole 12 is approximately 5.5 millimeters in diameter and its center is spaced a distance D_{TOP} away from the center of top slot 8 and a distance D_{BOTTOM} away from bottom slot 9. D_{TOP} is approximately 25 millimeters, while D_{BOTTOM} is approximately 9 millimeters. These dimensions represent one embodiment of the present invention. It is contemplated that a variety of other measurements may be used as well. Preferably, any adjustments will be made proportional to the dimensions provided.

FIGS. 3A and 3B provide alternate views of computer lock 2. Lock 2 comprises a height H_{L} extending from the end of top portion 32 to the end of bottom portion 34, an upper lock width W_{UL}, extending from first side 28 to second side 30 at top portion 32, and a bottom lock width W_{BL}, extending from first side 28 to second side 30 at bottom portion 34. In a preferred embodiment, H_{L} is approximately 41 millimeters, W_{UL} is approximately 20 millimeters, and W_{BL} is approximately 15 millimeters. Computer lock 2 also comprises a lock cylinder distance D_{L}, extending from the end of bottom portion 34 to the center of lock cylinder 6. In a preferred embodiment, D_{L} is approximately 16 millimeters. Lock 2 also comprises hook distance D_{H}, extending from back end 26 to the bend in hooks 4 and 5, and hook length L_{H}, representing the outer length of hooks 4 and 5. The inner length of hooks 4 and 5, which is the portion that extends down into corresponding slots 8 and 9, is preferably about half the size of L_{H}. In a preferred embodiment, D_{H} is approximately 2.8 millimeters and L_{H} is approximately 7 millimeters. These dimensions represent one embodiment of the present invention. It is contemplated that a variety of other measurements may be used as well. Preferably, any adjustments will be made proportional to the dimensions provided.

The present invention provides many advantages. The specific dimensions and locations of the two hooks and center locking cylinder allow for a very low-profile, compact body, while still accommodating a security cable slot and cable trap. Other locks are either much larger in size or fail to protect peripheral devices against theft. Additionally, the two hooks are positioned on the back end of the lock in such a way that once locked into a computer's chassis, the hooks are protected against prying and other attacks using various tools. In this fashion, the computer lock's body serves to house the hooks against damage when the computer lock is locked into a computer chassis. Furthermore, the simple hook, slide and push-button operation of the computer lock makes it considerably more intuitive and user-friendly than other locks. No key and very little manipulation is required in order to lock anchor the computer chassis to a secure object using the lock of the present invention. Moreover, the present invention uses three metal parts, the two hooks and the post of the lock cylinder to lock into a computer's chassis. Similar computer security devices have only one or two such parts. Therefore, the present invention is stronger than these other devices

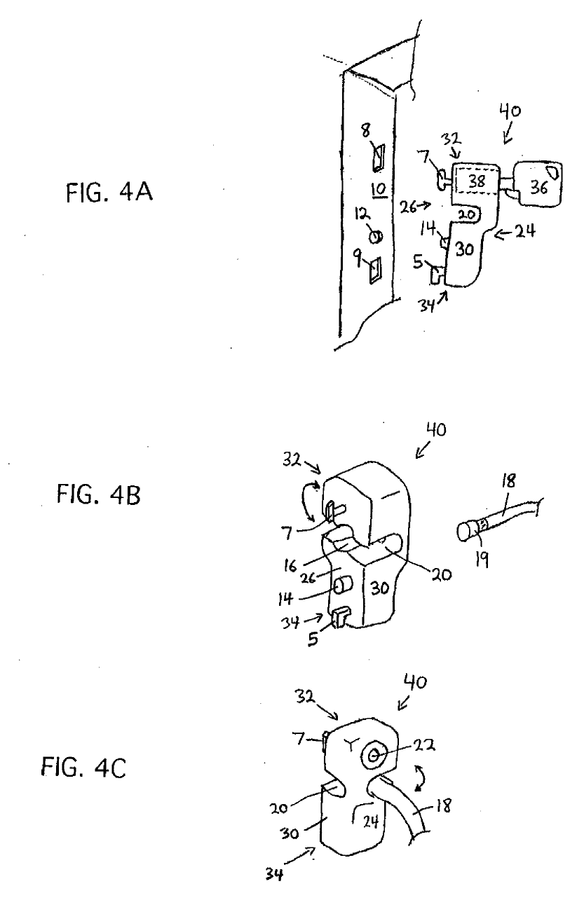

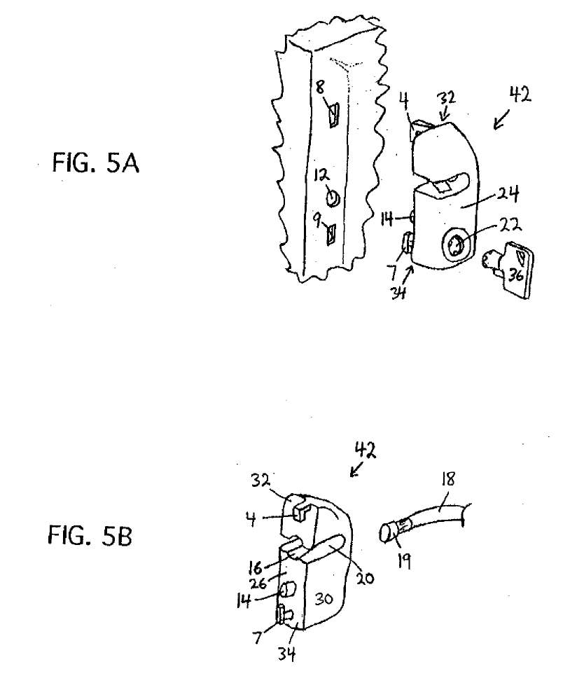

FIGS. 4A-5C illustrate alternative embodiments of the computer lock of the present invention, wherein the center post is fixed and one of the two hooks rotates. In these alternative embodiments, a lock cylinder 38 is physically and operationally connected to rotating hook 7, thereby controlling its rotation. Similar to hooks 4 and 5, rotating hook 7 may comprise any hook-shape that is curved or bent back at an angle such that it can catch hold of another structure, such as chassis 10. Such shapes may include the substantially L-shaped design previously discussed. However, in a preferred embodiment, rotating hook 7 is configured in the shape of a T-bar.

Unlike center post 14 of computer lock 2, center post 14 of locks 40 and 42 in FIGS. 4A-5B is not operated by a lock cylinder. Instead, in these alternative embodiments, center post 14 maintains a fixed position. Only rotating hook 7 may be adjusted. Lock cylinder 38 is configured to rotate rotating hook 7 from a position capable of entering the corresponding slot on chassis 10 to a position incapable of exiting the corresponding slot upon the use of key 36 or some other suitable means for controlling lock cylinder 38. In a preferred embodiment, lock cylinder 38 is configured to rotate rotating hook 7 approximately 90 degrees about the lengthwise axis of lock cylinder 38. However, it is contemplated that the degree of rotation employed may vary.

FIGS. 4A-4C illustrate computer lock 40 having rotating hook 7 as the top hook and a fixed bottom hook 5. In this configuration, bottom hook 5 is first placed at an angle in bottom slot 9 so that it is resting on the bottom shelf of bottom slot 9 and top portion 32 of lock 40 is angled away from chassis 10. Top portion 32 is then brought towards chassis 10, with center post 14 entering hole 12 and rotating hook 7 finally entering top slot 8. Key 36 may then be used to engage lock cylinder 38 and turn rotating hook 7 to a position where it rests next to the interior wall of chassis 10 (not shown), thereby preventing computer lock 40 from being pulled away from chassis 10. In order to detach lock 40 from chassis 10, key 36 may be used to engage lock cylinder 38 and turn rotating hook 7 back to its original position capable of passing through top slot 8. Top portion 32 may then be pulled away from chassis 10, with rotating hook exiting top slot 8 and center post 14 exiting hole 12. Finally, lock 40 may be lifted up so that bottom hook 5 no longer rests on the bottom shelf of bottom slot 9 and is capable of exiting bottom slot 9.

FIGS. 5A-5B illustrate computer lock 42 having rotating hook 7 as the bottom hook and a fixed top hook 4. In this configuration, top hook 4 is first placed at an angle in top slot 8 so that it is resting on the bottom shelf of top slot 8 and bottom portion 34 of lock 42 is angled away from chassis 10. Bottom portion 34 is then brought towards chassis 10, with center post 14 entering hole 12 and rotating hook 7 finally entering bottom slot 9. Key 36 may then be used to engage lock cylinder 38 and turn rotating hook 7 to a position where it rests next to the interior wall of chassis 10 (not shown), thereby preventing computer lock 42 from being pulled away from chassis 10. In order to detach lock 42 from chassis 10, key 36 may be used to engage lock cylinder 38 and turn rotating hook 7 back to its original position capable of passing through bottom slot 9. Bottom portion 34 may then be pulled away from chassis 10, with rotating hook exiting bottom slot 9 and center post 14 exiting hole 12. Finally, lock 42 may be lifted up so that top hook 4 no longer rests on the bottom shelf of top slot 8 and is capable of exiting top slot 8.

The present invention may be applied to any type of computer, whether it be a desktop or laptop. In fact, it is contemplated that the present invention may be applied to any product, computer or non-computer related, that comprises a surface capable of supporting the security hole pattern disclosed herein.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiment disclosed as the best mode contemplated for carrying out this invention.

What is claimed is:

1. A computer lock comprising:
a lock body having a front end, a back end opposite said front end, a first side adjacent to said back end, a second side opposite said first side and adjacent to said back end, a top portion, and a bottom portion opposite said top portion;
a top hook disposed on said top portion between said first side and said second side, said top hook protruding outward from said back end;
a bottom hook disposed on said bottom portion between said first side and said second side, said bottom hook protruding outward from said back end;
a post disposed in between said top hook and said bottom hook and between said first side and said second side, said post configured to protrude outward from said back end either in a fixed position or in an adjustable position; and
an opening disposed in between said top hook and said bottom hook and extending from said back end towards said front end, said opening having a security cable slot and a cable trap formed therein, wherein said security cable slot is configured to receive and anchor a security cable having an elongated body and an end that is greater in diameter than said elongated body, and said cable trap is configured to receive cables and trap said cables in between said front end and a surface to which said back end is secured.

2. The computer lock of claim 1, wherein said computer lock is formed from metal.

3. The computer lock of claim 1, wherein said top hook, said bottom hook and said post all comprise substantially the same horizontal position on said back end.

4. The computer lock of claim 1, wherein said post is disposed closer to said bottom hook than said top hook.

5. The computer lock of claim 1, wherein said opening comprises a first diameter and a second diameter larger than said first diameter, wherein said first diameter extends from said back end all the way to said front end and said second diameter extends from said back end to a location preceding said front end.

6. The computer lock of claim 5, wherein said opening extends along said first side from said back end to a location preceding said first end and said opening extends along said second side from said back end all the way to said front end, thereby allowing said elongated body of said security cable to placed through said second side and then pulled away from said back end and towards said front end.

7. The computer lock of claim 6, wherein said second diameter is disposed in between said first side and said second side.

8. The computer lock of claim 5, further comprising a lock cylinder disposed in between said top hook and said bottom hook and operationally connected to said post, said lock cylinder configured to be engaged by a user from said front end, wherein said user can move said post from a position in between said back end and said front end to a locked position extending outward from said back end.

9. The computer lock of claim 8, wherein said lock cylinder is a push-button lock cylinder.

10. The computer lock of claim 8, wherein said top hook and said bottom hook have a fixed position and orientation.

11. The computer lock of claim 8, wherein the end of said top hook and the end of said bottom hook comprise a member that extends downward away from said top portion.

12. The computer lock of claim 5, further comprising a lock cylinder physically and operationally connected to said top hook, said lock cylinder configured to be engaged by a user from said front end, wherein said top hook is configured to be rotated by said user through the engagement of said lock cylinder.

13. The computer lock of claim 12, wherein said bottom hook has a fixed position and orientation.

14. The computer lock of claim 12, wherein said top hook comprises a T-bar shape.

15. The computer lock of claim 5, further comprising a lock cylinder physically and operationally connected to said bottom hook, said lock cylinder configured to be engaged by a user from said front end, wherein said bottom hook is configured to be rotated by said user through the engagement of said lock cylinder.

16. The computer lock of claim 15, wherein said top hook has a fixed position and orientation.

17. The computer lock of claim 15, wherein said bottom hook comprises a T-bar shape.

18. The computer lock of claim 1, wherein said back end is substantially planar with the exception of said top hook, said bottom hook and said post, said top hook, said bottom hook and said post being the only protrusions extending outward from said back end.

19. A security hole pattern for a computer chassis comprising:
a top slot disposed on said computer chassis, said top slot configured to receive and support a top hook;
a hole disposed on said computer chassis in a position below said top slot, said hole configured to receive and support a post; and
a bottom slot disposed on said computer chassis in a position below said hole, said bottom slot configured to receive and support a bottom hook,
wherein said top slot, said hole and said bottom slot all comprise substantially the same horizontal position on said computer chassis.

20. The security hole pattern of claim 19, wherein said hole is disposed in a location closer to said bottom slot than said top slot.

21. The security hole pattern of claim 20, wherein the ratio between the distance from the center of said hole to the center of said top slot and the distance from the center of said hole to the center of said bottom slot is about 25:9.

22. The security hole pattern of claim 21, wherein the distance from the center of said hole to the center of said top slot is about 25 millimeters and the distance from the center of said hole to the center of said bottom slot is about 9 millimeters.
